(19) United States
(12) Patent Application Publication
(10) Pub. No.: US 2009/0317136 A1
(43) Pub. Date: Dec. 24, 2009

(54) MULTILAYERED ELECTROPHOTOGRAPHIC PHOTORECEPTOR AND IMAGE FORMATION APPARATUS PROVIDED WITH THE SAME

(75) Inventors: Hiroshi SUGIMURA, Osaka (JP); Akihiro KONDOH, Osaka (JP)

Correspondence Address: NIXON & VANDERHYE, PC, 901 NORTH GLEBE ROAD, 11TH FLOOR, ARLINGTON, VA, 22203, US

(73) Assignee: SHARP KABUSHIKI KAISHA, Osaka-shi (JP)

(21) Appl. No.: 12/468,392

(22) Filed: May 19, 2009

(30) Foreign Application Priority Data
May 20, 2008 (JP) 2008-132192

(51) Int. Cl. G03G 15/04; G03G 5/04

(52) U.S. Cl. 399/220; 430/58.65

(57) ABSTRACT

A multilayered electrophotographic photoreceptor comprising at least a charge generation layer containing a charge generation material and a charge transport layer containing a charge transport material in this order, on a conductive support, wherein the charge transport layer contains, as the charge transport material, an amine type compound represented by the following formula (I):

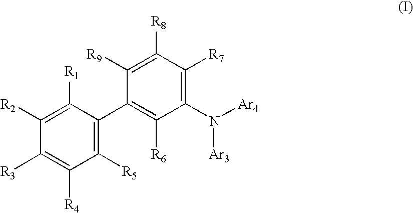

wherein R₁ to R₉, which may be the same or different, respectively represent a hydrogen atom; a halogen atom; or an alkyl, cycloalkyl, alkenyl or alkoxy group which may have a substituent, provided that either one of R₂ and R₃ represents —N(Ar₁)(Ar₂); and Ar₁ to Ar₄, which may be the same or different, respectively represent an aromatic hydrocarbon residue or an aromatic heterocyclic residue which may have a substituent, and Ar₁ and Ar₂, or Ar₃ and Ar₄ may be combined with each other to form a condensed ring; and has photosensitive properties in coherent light of wavelength range from 400 to 450 nm.

### CROSS-REFERENCE TO RELATED APPLICATIONS

This application is related to Japanese Patent Application No. 2008-132192 filed on May 20, 2008 whose priority is claimed under 35 USC § 119, the disclosure of which is incorporated by reference in its entirety.

### BACKGROUND OF THE INVENTION

1. Field of the Invention

The present invention relates to a multilayered electrophotographic photoreceptor which is suitably used in an electrophotographic type image formation apparatus provided with an exposure means for forming an electrostatic latent image by exposure using a blue semiconductor laser which is coherent light having a wavelength range from 400 to 450 nm, and to an image formation apparatus provided with the multilayered electrophotographic photoreceptor.

2. Description of the Related Art

Many electrophotographic system image formation apparatuses (hereinafter also referred to as an “electrophotographic device”) utilizing electrophotographic technologies to form an image are used for copying machines, printers, facsimile machines and the like.

In electrophotographic device s, an image is formed through electrophotographic processes mentioned below.

First, a photosensitive layer of an electrophotographic photoreceptor (hereinafter also called “photoreceptor”) provided in an device is charged uniformly to a prescribed potential by a charging means and then exposed to light such as laser light emitted corresponding to image information from an exposure means to form an electrostatic latent image. Then, a developer is supplied from a developing means to the formed electrostatic latent image to stick colored microparticles called a toner, which is a developer component to the surface of the photoreceptor, thereby developing the electrostatic latent image to visualize the electrostatic latent image as a toner image. Then, the formed toner image is transferred to a transfer receiving material such as recording paper from the surface of the photoreceptor by a transfer means and fixed to the transfer receiving material by a fixing means to form a desired image on the transfer receiving material.

In the transfer operation using the transfer means, toners on the surface of the photoreceptor are not entirely transferred and shifted to the recording paper but partly remain on the surface of the photoreceptor. Also, there is the case where a paper powder of the recording paper in contact with the photoreceptor during transfer remains stuck to the surface of the photoreceptor. Also, foreign substances such as residual toners and stuck paper powders on the surface of the photoreceptor exert an adverse influence on the quality of the formed image, and are therefore removed by a cleaner.

Also, an improvement has been recently made in technologies concerning a cleaner-less system, in which residual toners are recovered (or removed) by a cleaning function (as a developer and a cleaning system) to be added to a developing means without using an independent cleaning means. After the surface of the photoreceptor is cleaned in this manner, charges on the surface of a photosensitive layer are removed by a charge remover or the like to extinguish the electrostatic latent image.

Such a photoreceptor used in the electrophotographic process has a structure in which a photosensitive layer containing a photoconductive material is layered on a conductive support.

As the photoreceptor conventionally used, an electrophotographic photoreceptor (hereinafter, referred to as an “inorganic photoreceptor”) provided with a photosensitive layer containing an inorganic photoconductive material as its major component is widely used. Typical examples of the inorganic photoreceptor include selenium type photoreceptors using a layer constituted of amorphous selenium (a-Se) or amorphous selenium arsenic (a-AsSe) as the photosensitive layer; zinc oxide type photoreceptors or cadmium sulfide type photoreceptors using, as the photosensitive layer, a material obtained by dispersing zinc oxide (ZnO) or cadmium sulfide (CdS) together with sensitizers such as dyes in a resin; and amorphous silicon type photoreceptors (a-Si photoreceptors) using a layer containing amorphous silicon (a-Si) as the photosensitive layer.

However, the inorganic photoreceptors have the following drawbacks.

The selenium or cadmium sulfide type photoreceptors have problems concerning heat resistance and storage stability and also, selenium and cadmium are toxic to human bodies and environments. It is therefore necessary to recover and to properly dispose of photoreceptors using these metals after they have been used.

The zinc oxide type photoreceptors have the drawback that they are low in sensitivity and durability and are therefore scarcely used at present.

The a-Si photoreceptors attract remarkable attention as pollution-free inorganic photoreceptors and have the advantage that they have high sensitivity and durability, but on the contrary, have the disadvantage that they have difficulties in forming the photosensitive layer uniformly, easily generate image defects, are reduced in productivity and the production costs are high because these photoreceptors are produced by a plasma enhanced chemical vapor growth deposition.

Because these inorganic photoreceptors have many drawbacks, photoreceptors (hereinafter also referred to as an “organic photoreceptor”) using an organic photoconductive material, that is, an organic photoreceptor (abbreviation: OPC) have been studied and developed to be a leading photoreceptor.

Although these organic photoreceptors have some problems concerning sensitivity, durability and stability to the environment, they have larger merits than inorganic photoreceptors in view of toxicity, production cost and degree of freedom of material designs. For example, the photosensitive layer of the organic photoreceptors can be formed using easy and inexpensive methods typified by the dip coating method.

As the structure of such an organic photoreceptor, various structures have been proposed, and these structures includes a monolayer structure in which a charge generation material and a charge transport material are both dispersed in a binding resin and formed on a conductive support, and a laminate structure or reverse double layer type laminate structure in which a charge generation layer obtained by dispersing a charge generation material in a binding resin and a charge transport layer obtained by dispersing a charge transport material in a binding resin are formed in this order or reverse order on a conductive support. Among these structures, a functional separation type photoreceptor in which a charge transport layer is layered on a charge generation layer as the photosensitive layer is excellent in electrophotographic characteristics and durability and also has a high degree of freedom of material selection. Therefore, the photoreceptor characteristics can be variously designed and the function separation type photoreceptors are hence widely put to practical use.

In the meantime, typical examples of an image formation apparatus (also, called “electrophotographic device”) provided with a laser as the light source for exposure (also simply called “exposure light source”) include a laser printer. In recent years, progress of digitalization has been made in the field of copying machines. The use of a laser for the exposure light source has come to be generalized.

As a laser used for the exposure light source, a semiconductor laser which is inexpensive, is reduced in energy consumption and is small-sized and light-weight has been put to practical use and a laser having an oscillation wavelength close to 800 nm in the near-infrared region is generally used in the points of the stability of oscillation wavelength and output and life. This is because that no laser oscillating at short wavelengths has been put to practical use due to technological problems.

This is the reason why organic compounds which absorb light in a long-wavelength region and showing sensitivity, particularly phthalocyanine pigments have been developed as the charge generation material constituting the photosensitive layer of the photoreceptor used in an image formation apparatus provided with a laser as the exposure light source.

The method of producing a blue light-emitting diode (see U.S. Pat. No. 5,334,277) was invented in 1990. After that, technologies concerning the blue semiconductor laser have been developed enthusiastically so far and next generation disks called blue ray disks have been prevailing rapidly.

In the meantime, studies as to an improvement in the resolution of image quality have been recently made to improve the image quality of an image output from an image formation apparatus. An optical method in which the diameter of the spot of a laser beam is limited to thereby improve writing density is given as an example of measures taken to attain an image improved in recording density and resolution. Although this can be accomplished by reducing the focal distance of a lens to be used there, it is difficult to design the optical system and also, there is the problem that a laser having an oscillation wavelength close to 800 nm in the near-infrared region has a difficulty in obtaining the distinctness of the outline of the spot even if the diameter of the beam is narrowed by the operation of the optical system. This is caused by the diffraction limit of laser light and is an unavoidable phenomenon.

Generally, a spot diameter D of laser light (laser beam) converged on the surface of a photoreceptor is given by the following equation when the wavelength of the laser beam (oscillation wavelength of the laser light) is defined as λ and the numerical aperture of the lens is defined as NA.

D=1.22λ/NA

According to this equation, the spot diameter D is rational to the oscillation wavelength of the laser light and therefore, it is understood that it is only required to use a laser having a short oscillation wavelength to reduce the spot diameter D.

In other words, it is understood that an image quality having higher resolution can be attained if a blue semiconductor laser is used in place of a near-infrared semiconductor laser which is currently one of the leading semiconductor lasers.

Generally, the laminate type photoreceptor contains a resin component in a large amount and is provided with a charge transport layer on the surface side and a charge generation layer on the conductive support side to protect the charge generation layer low in the strength of the film with the charge transport layer having high film strength.

In such a structure, the light emitted from an exposure light source is allowed to pass (is transmitted) through the charge transport layer on the surface side and reaches the charge generation layer, where charges are generated. One charge flows towards the conductive support side and the other moves to the surface side by an electric field to eliminate electrified charges on the surface. For this reason, the charge transport layer is required to be transparent for light having a wavelength falling in the exposure wavelength region and is therefore required to transmit light having a wavelength falling in the exposure wavelength region.

Also, the laminate type organic photoreceptor is classified into a negatively charged system in which the charge transport material which is a major functional component is a hole transport material and a positively charged system in which the charge transport material is an electron transport material.

In the research and development of the organic photoreceptor, the development of a hole transport material having an excellent charge transport capability takes precedence and therefore, the negatively charged system photoreceptor has been put to practical use.

Also, in an image formation apparatus, the above charging, exposing, developing, transfer, cleaning and charge-removal operations of the photoreceptor are repeatedly performed in various environments and therefore, the photoreceptor is required to have high sensitivity and excellent responsibility to light and also, high environmental stability, electrical stability and resistance (scratching resistance) to external mechanical force. Particularly, it is required of the surface layer of the photoreceptor to be resistant to abrasion caused by the scratch action of a cleaning member or the like.

In the laminate type photoreceptor used in an image formation apparatus provided with a blue semiconductor laser, it is necessary to use a material absorbing light having a wavelength of 400 to 450 nm (for example, 405 nm) which is the oscillation wavelength of a blue semiconductor laser as the charge generation material of the charge generation layer and it is also necessary to use a material which does not absorb light having the oscillation wavelength of a blue semiconductor laser as the charge transport material of the charge transport layer.

This is because it is necessary to prevent a situation where the light having the oscillation wavelength of a blue semiconductor laser is absorbed by the charge transport layer layered on the charge generation layer, particularly, by the charge transport material.

For this reason, compounds such as pyrazoline and hydrazone which absorb light having the oscillation wavelength of a blue semiconductor laser and are conventionally used practically as the charge transport material cannot be used and a triarylamine type compound reduced in the absorption of such light is proposed. Conventional examples include Japanese Unexamined Patent Publications No. 2002-40687, JP-A 2000-147874, No. 2002-23395 and No. 2002-55463.

Also, in Hiroaki TANAKA and three others “Molecular design (II) to improve drift mobility in an organic photoconductive material-Chemical structure of a triphenylamine derivative and drift mobility,” the Society of Electrophotography of Japan, the 60th conference, Dec. 4, 1987, pp. 90-94, there is the description that studies of a difference in drift mobility as a function of a difference in the bonding position, that is, the metha position and the para position, leads to the results that the mobility is higher at the metha position than at the para position and to the conclusion that a molecule smaller in the bias of electronic density in a cation radical state is higher in mobility from the results of the calculation of the distribution of electronic density.

### SUMMARY OF THE INVENTION

According to a first aspect of the present invention, there is provided a multilayered electrophotographic photoreceptor comprising at least a charge generation layer containing a charge generation material and a charge transport layer containing a charge transport material in this order, on a conductive support, wherein the charge transport layer contains, as the charge transport material, an amine type compound represented by the following formula (I):

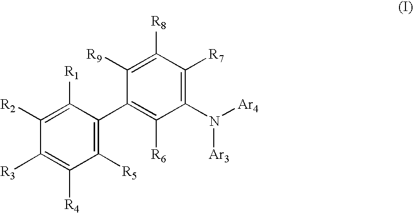

wherein R₁ to R₉, which may be the same or different, respectively represent a hydrogen atom; a halogen atom; or an alkyl, cycloalkyl, alkenyl or alkoxy group which may have a substituent, provided that either one of R₂ and R₃ represents —N(Ar₁)(Ar₂); and Ar₁ to Ar₄, which may be the same or different, respectively represent an aromatic hydrocarbon residue or an aromatic heterocyclic residue which may have a substituent, and Ar₁ and Ar₂, or Ar₃ and Ar₄ may be combined with each other to form a condensed ring; and has photosensitive properties in coherent light of wavelength range from 400 to 450 nm.

Also, according to a second aspect of the present invention, there is provided an image formation apparatus comprising the multilayered electrophotographic photoreceptor as mentioned above, a charge means for charging the multilayered electrophotographic photoreceptor, an exposure means for exposing the charged multilayered electrophotographic photoreceptor to coherent light having a wavelength range from 400 to 450 nm to form an electrostatic latent image, a developing means for developing the electrostatic latent image formed by the exposure to visualize the image, and a transfer means for transfer the image visualized by the developing to a recording medium.

The term “coherent light” in the present invention means light which is of such a nature that two waves can be interfered with each other, that is, light having coherency.

### BRIEF DESCRIPTION OF THE DRAWINGS

FIG. 1 is a schematic sectional view showing the structure of an essential part of a multilayered electrophotographic photoreceptor according to the present invention;

FIG. 2 is a schematic sectional view showing the structure of an essential part of a multilayered electrophotographic photoreceptor according to the present invention;

FIG. 3 is a schematic sectional view showing the structure of an essential part of a multilayered electrophotographic photoreceptor according to the present invention;

FIG. 4 is a schematic sectional view showing the structure of an essential part of a multilayered electrophotographic photoreceptor according to the present invention;

FIG. 5 is a schematic side view showing a structure of an image formation apparatus according to the present invention; and

FIG. 6 is a view showing photo-induced discharge properties of a multilayered electrophotographic photoreceptor.

### DETAILED DESCRIPTION OF THE INVENTION

However, the conventional charge transport material as mentioned above is still insufficient in transmittance for light (blue laser light) having the oscillation wavelength of a blue semiconductor laser.

Generally, charges are conveyed by exchange of π-electrons in organic photoconductive materials. The larger the spreading of the π-electron conjugate of the organic photoconductive material is, the higher the charge mobility of the organic photoconductive materials is.

On the other hand, the spreading of the π-electron conjugate makes the absorption spectrum have a longer wavelength.

For this reason, a charge transport material having high charge mobility required for high sensitization has a light-absorption region spread to the oscillation wavelength region of the blue semiconductor laser by the development of the π-electron conjugate, with the result that the light cannot transmit the charge transport layer and therefore, satisfactory sensitivity cannot be attained.

In other words, it has been impossible to satisfy two contrary characteristics, that is, the transmittance for blue laser light and charge mobility, at the same time so far.

For example, if a charge transport material in which a substituent having steric hindrance is introduced into a phenyl group which is a center skeleton so as to cut the π-electron conjugate, the absorption wavelength is surely made to be shorter so that sufficient transmittance for blue laser light can be attained. However, the charge mobility is lowered at the same time and therefore, desired sensitivity is not obtained, with the result that the charge transport material cannot be used.

Therefore, it is an object of the present invention to provide a stable electrophotographic photoreceptor which is suitably used in an image formation apparatus provided with a blue semiconductor laser, has high sensitivity and high resolution, is excellent in scratching resistance and generates no image deterioration, and also to provide an image formation apparatus provided with the multilayered electrophotographic photoreceptor.

The inventors of the present invention have found that two contrary characteristics, that is, the transmittance for blue laser light and charge mobility, can be satisfied at the same time by using a specific amine type compound as the charge transport material, to complete the present invention.

The multilayered electrophotographic photoreceptor of the present invention (also referred to as a “laminate type photoreceptor” or simply as a “photoreceptor”) has at least a charge generation layer containing a charge generation material and a charge transport layer containing a charge transport material in this order, on a conductive support, wherein the charge transport layer contains, as the charge transport material, an amine type compound represented by the formula (I); and has photosensitivity properties in coherent light of wavelength range from 400 to 450 nm.

The present invention can provide a stable photoreceptor which is suitably used in an image formation apparatus provided with a blue semiconductor laser, has high sensitivity and high resolution, is excellent in scratching resistance and generates no image deterioration, and also to provide an image formation apparatus provided with the photoreceptor.

Specifically, blue semiconductor laser light used for the exposure light source is not absorbed in the charge transport layer but reaches the charge generation layer to generate charges, which are then injected into the charge transport layer and then transported to the surface by the charge transport material having high mobility to cancel the surface charges, thereby making it possible to attain high sensitivity.

It is inferred that the effect of the present invention is obtained by the following mechanism.

It is known that the substitution at the metha position of phenylamine constituting triphenylamine is made without π-electron conjugate. Therefore, the situation where the absorption wavelength is made longer by the spreading of the π-electrons is avoided by combining the phenyl groups as the center skeletons at the metha-position among them.

On the other hand, as described in TANAKA Hiroaki and three others “Molecular design (II) to improve drift mobility in an organic photoconductive material-Chemical structure of a triphenylamine derivative and drift mobility,” the Society of Electrophotography of Japan, the 60th conference, Dec. 4, 1987, pp. 90-94, it is known that the mobility is higher at the metha-position than at the para-position in phenylamine and a molecule smaller in the bias of electronic density in a cation radical state is higher in mobility.

It is inferred that the above two effects enable the mobility to be improved without making the absorption wavelength longer by combining the phenyl groups as the center skeletons at metha-positions.

The amine type compound used as the charge transport material in the present invention is represented by the formula (I).

R₁ to R₉ in the formula (I), which may be the same or different, respectively represent a hydrogen atom; a halogen atom; or an alkyl, cycloalkyl, alkenyl or alkoxy group which may have a substituent, provided that either one of R₂ and R₃ represents —N(Ar₁)(Ar₂).

The description “which may have a substituent” means that each of the above groups may be substituted with a halogen atom, a lower alkyl group and the like.

Examples of the halogen atom include a fluorine atom, a chlorine atom, a bromine atom and an iodine atom.

Examples of the alkyl group include alkyl groups having 1 to 4 carbon atoms such as a methyl group, an ethyl group, a propyl group, an isopropyl group, a butyl group, an isobutyl group, a sec-butyl group and a tert-butyl group.

Examples of the cycloalkyl group include cycloalkyl groups having 3 to 6 carbon atoms such as a cyclopropyl group, a cyclobutyl group, a cyclopentyl group and a cyclohexyl group.

Examples of the alkenyl group include alkenyl groups having 1 to 4 carbon atoms such as a vinyl group, an allyl group, an isopropenyl group, a 1-butenyl group and a 2-butenyl group.

Examples of the alkoxy group include alkoxy groups having 1 to 4 carbon atoms such as a methoxy group, an ethoxy group, a propoxy group, an isopropoxy group, a butoxy group and an isobutoxy group.

Among these groups, a fluorine atom, a chlorine atom, a methyl group, an ethyl group, an isopropyl group, a trifluoromethyl group, a tert-butyl group, a cyclohexyl group, a methoxy group, an ethoxy group, an isopropoxy group and a butoxy group are preferable.

Also, Ar₁ to Ar₄ in the formula (I), which may be the same or different, respectively represent an aromatic hydrocarbon residue or an aromatic heterocyclic residue which may have a substituent, and Ar₁ and Ar₂, or Ar₃ and Ar₄ may be combined with each other to form a condensed ring.

The description “which may have a substituent” means that each of the above residues may be substituted with a halogen atom, a lower alkyl group or the like.

Examples in which a condensed ring is formed include carbazolyl rings of the exemplified compounds No. 1-8 which will be mentioned later.

Examples of the aromatic hydrocarbon residue which may have a substituent include a phenyl group, a biphenyl group, a naphthyl group, a binaphthyl group, an anthryl group and a phenanthryl group.

Examples of the aromatic heterocyclic residue which may have a substituent include a pyrrolyl group, a pyrrolidyl group, a pyrazolyl group, an imidazolyl group, a pyridyl group, a benzimidazolyl group, a benzthiazolyl group and a benzoxazolyl group.

R₁, R₅, R₆ and R₉ in the formula (I) are preferably respectively a hydrogen atom.

Amine type compounds represented by the formula (I) in which R₂, R₄, R₇ and R₈ are respectively a hydrogen atom, R₃ is —N(Ar₁)(Ar₂) and Ar₁, Ar₂, Ar₃ and Ar₄ are respectively a group selected from phenyl, m-tolyl, p-tolyl, mesityl, 1-naphthyl, 2-naphthyl, 4-biphenylyl, m-ethylphenyl and 9-anthryl or a 9-carbazolyl group formed from Ar₁ and Ar₂ combined with each other are preferably.

In the above case, a combination of Ar₁ and Ar₂ is preferably the same as a combination of Ar₃ and Ar₄.

Amine type compounds represented by the formula (I) in which R₂, R₄ and R₈ are respectively a hydrogen atom, R₇ is a hydrogen atom or a methyl group, R₂ is —N(Ar₁)(Ar₂) and Ar₁, Ar₂, Ar₃ and Ar₄ are respectively a group selected from phenyl, m-tolyl, p-tolyl, 2-naphthyl, 4-biphenylyl, 9-phenanthryl and 9-anthryl are preferably.

In the above case, a combination of Ar₁ and Ar₂ is preferably the same as a combination of Ar₃ and Ar₄.

In the amine type compound represented by the formula (I), specific examples of the amine type compound when R₃ is —N(Ar₁)(Ar₂) are typified by the exemplified compounds No. 1-1 to No. 1-12 and specific examples of the amine type compound represented by the formula (I) when R₂ is —N(Ar₁)(Ar₂) are typified by the exemplified compounds No. 2-1 to No. 2-11. Among these compounds, the exemplified compounds No. 1-3, [3,4′-bis(N-phenyl-N-m-tolylamino)biphenyl] and No. 2-3, [3,3′-bis(N-phenyl-N-m-tolylamino)biphenyl] are particularly preferable.

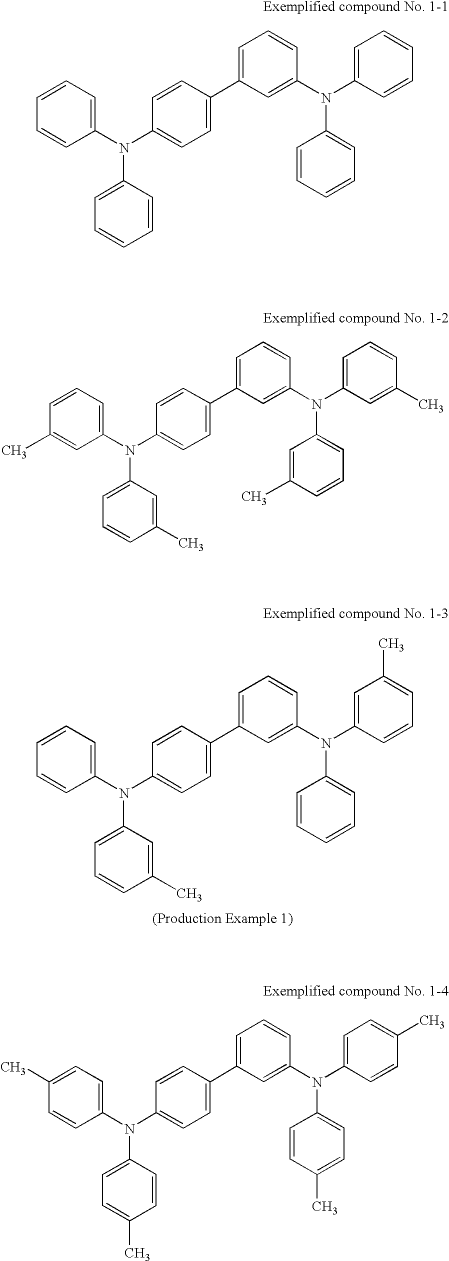

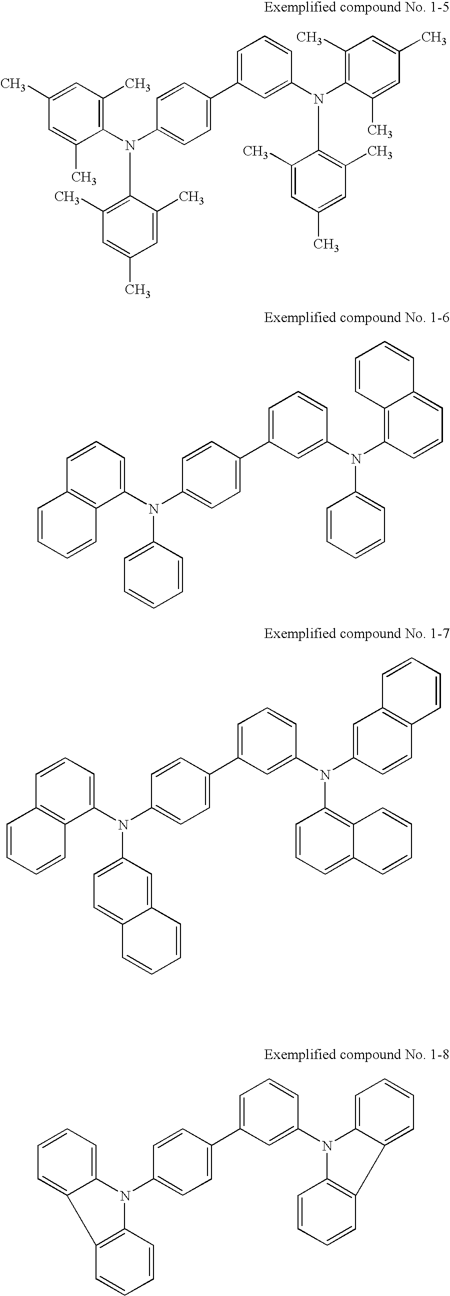

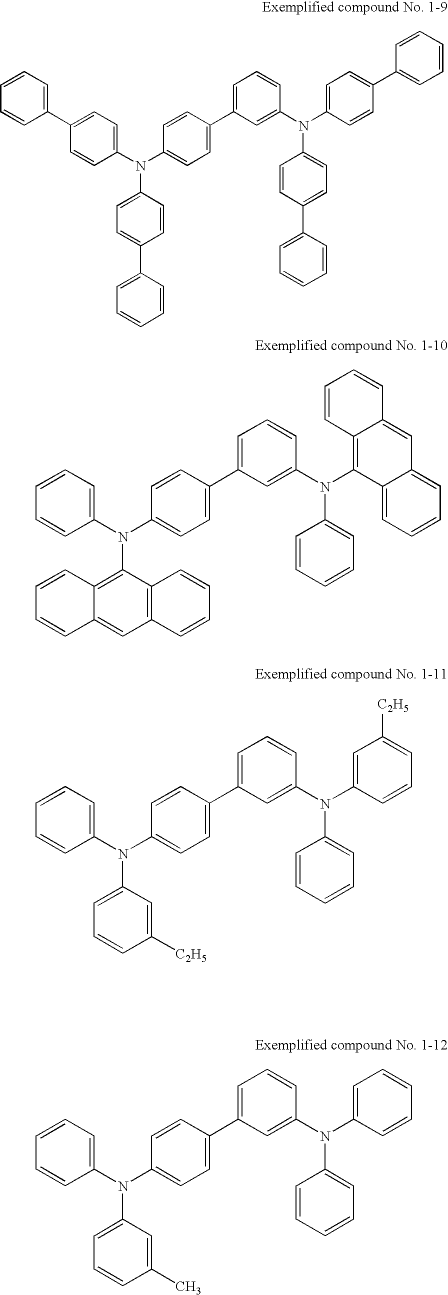

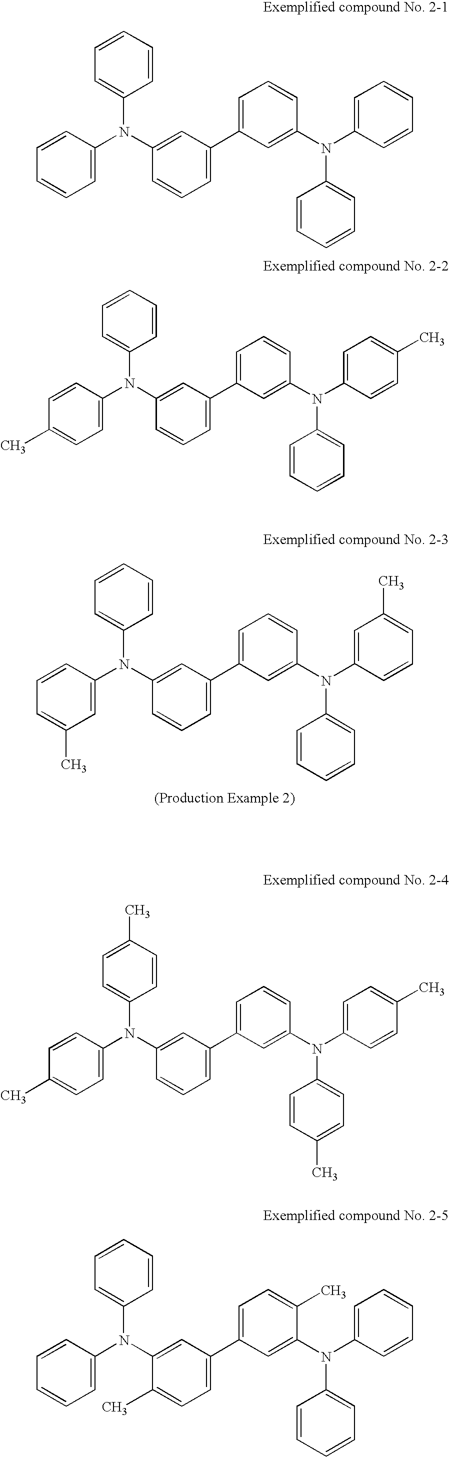

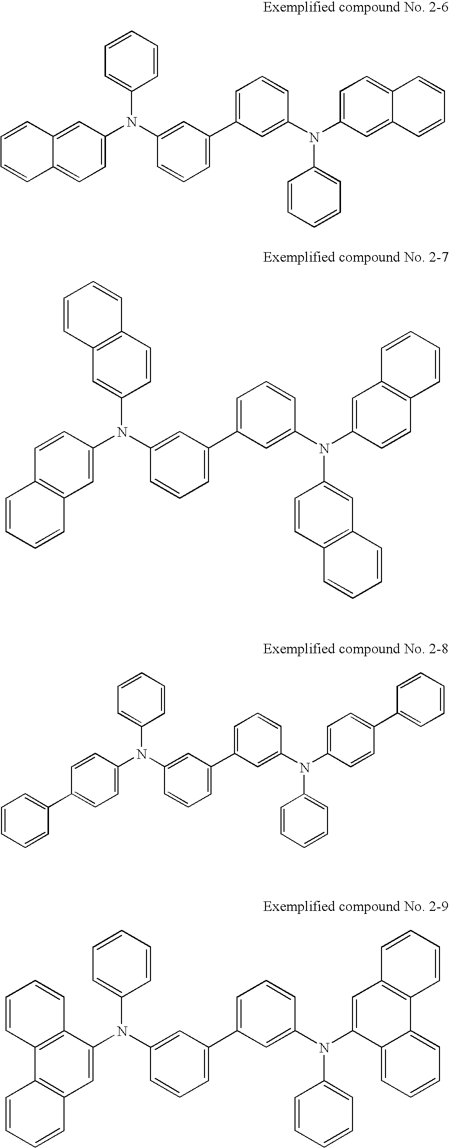

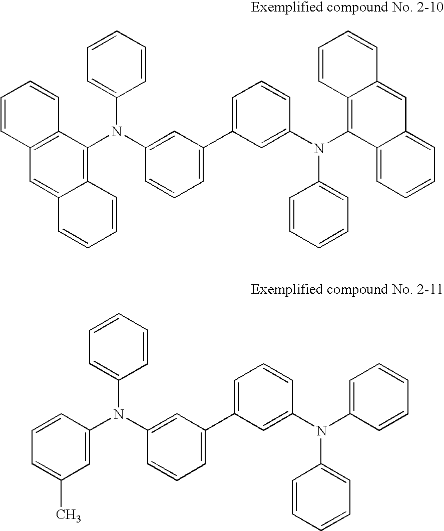

Next, the structure of the multilayered electrophotographic photoreceptor of the present invention will be described in detail.

FIG. 1 to FIG. 4 are each a schematic sectional view showing the structure of an essential part of a multilayered electrophotographic photoreceptor according to the present invention.

A laminate type photoreceptor 20a in FIG. 1 includes a conductive support 13a, and a charge generation layer 11a and a charge transport layer 12a which are formed in this order on the conductive support 13a.

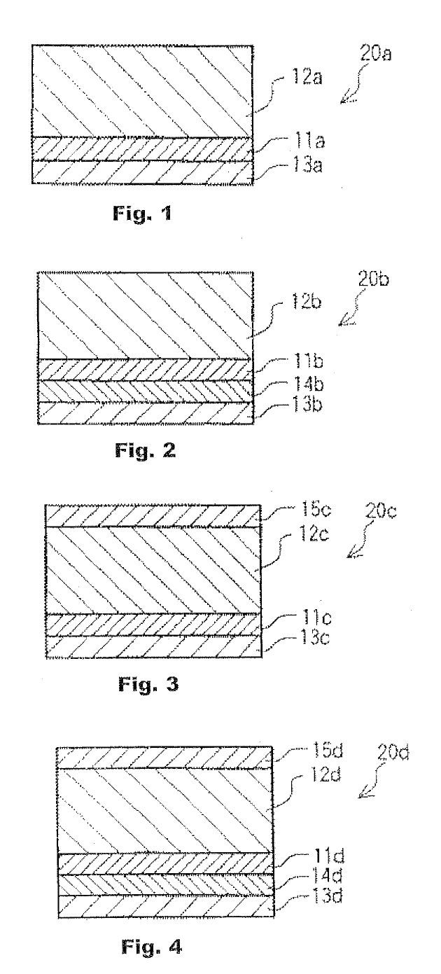

A laminate type photoreceptor 20b in FIG. 2 includes a conductive support 13b, and an intermediate layer 14b and a charge generation layer 11b and a charge transport layer 12b which are formed in this order on the conductive support 13b.

A laminate type photoreceptor 20c in FIG. 3 includes a conductive support 13c, and a charge generation layer 11c, a charge transport layer 12c and a protective layer 15c which are formed in this order on the conductive support 13c.

A laminate type photoreceptor 20d in FIG. 4 includes a conductive support 13d, and an intermediate layer 14d and a charge generation layer 11d, a charge transport layer 12d and a protective layer 15d which are formed in this order on the conductive support 13d.

These laminate type photoreceptors are allowed to charge and exposed to coherent light of wavelength range from 400 to 450 nm, thereby making it possible to form an electrostatic latent image having high resolution.

(Conductive Supports 13a, 13b, 13c and 13d)

The conductive support has a function as the electrode of the laminate type photoreceptor and a function as the support member and any material may be used as the constituent material of the conductive support without any particular limitation insofar as it is used in the field concerned.

Specific examples of the conductive support material include metal materials such as aluminum, aluminum alloys, copper, zinc, stainless steel and titanium; and materials obtained by laminating a metal foil on the surface of a support made from a polymer material such as polyethylene terephthalate, polyamide, polyester, polyoxymethylene or polystyrene, hard paper or glass; materials obtained by vapor-depositing a metal material on the surface of a support; and materials obtained by vapor-depositing or applying a layer of a conductive compound such as a conductive polymer, tin oxide or indium oxide on the surface of a support.

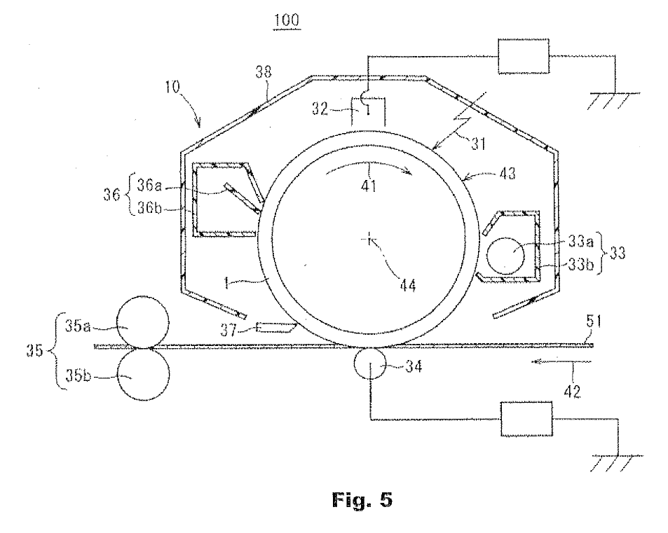

The shape of the conductive support is not limited to a sheet form as shown in FIG. 1 to FIG. 4 and to a cylinder form as shown in FIG. 5 which will be described later and may be a columnar form or an endless belt form.

The surface of the conductive support may be treated by anodic oxidation coating treatment, surface treatment using chemicals or hot water, coloring treatment or irregular reflection treatment such as surface roughing treatment as necessary to the extent that the image quality is not adversely affected.

The irregular reflection treatment is particularly effective when the laminate type photoreceptor of the present invention is used in an electrophotographic process using a laser as the exposure light source. Specifically, in the electrophotographic process using a laser as the exposure light source, the wavelengths of laser light are even. Therefore, there is the case where laser light reflected on the surface of the photoreceptor interferes with the light reflected inside of the photoreceptor, resulting in appearance of interference fringes on an image, causing image defects. In this respect, the above image defects caused by the interference of laser light having even wavelengths can be prevented by treating the surface of the conductive support by irregular reflection treatment.

(Charge Generation Layers 11a, 11b, 11c, and 11d)

The charge generation layer contains a charge generation material which absorbs light having a wavelength of 400 to 450 nm to generate charges.

Specific examples of the materials effective as the charge generation material include materials having sensitivity to light in the above exposure wavelength region (wavelength: 400 to 450 nm) among organic photoconductive materials, for example, azo type pigments such as monoazo type pigments, bisazo type pigments and trisazo type pigments; indigo type pigments such as indigo and thioindigo; perylene type pigments such as perylene imide and perylenic acid anhydride; polycyclic quinone type pigments such as anthraquinone and pyrene quinone; phthalocyanine type pigments such as metal phthalocyanine such as oxotitanium phthalocyanine and metal-free phthalocyanine; squalilium dyes, pyrylium salts, thiopyrylium salts and triphenylmethane type dyes; and inorganic photoconductive materials such as selenium and amorphous silicon. These charge generation materials may be used either singly or in combinations of two or more.

The charge generation material may be used in combination with sensitizing dyes including triphenylmethane type dyes typified by Methyl Violet, Crystal Violet, Night Blue and Victoria Blue; acridine dyes typified by Erythrocin, Rhodamine B, Rhodamine 3R, Acridine Orange and Flapeocine; thiazine dyes typified by Methylene Blue and Methylene Green; oxazine dyes typified by Capri Blue and Meldola's Blue; cyanine dyes; styryl dyes; pyrylium salt dyes; or thiopyrylium salt dyes for the purpose of improving the functions.

The ratio of the sensitizing dye is preferably 10 parts by weight or less and more preferably 0.5 to 2.0 parts by weight based on 100 parts by weight of the charge generation material though there is no particular limitation to the ratio.

The charge generation layer may contain a binder resin for the purpose of improving its binding ability.

As the binder resin, a resin having the binding ability enough for use in the fields concerned may be used and those having high compatibility with the charge generation material are preferable.

Specific examples of the binder resin include polyester resins, polystyrene resins, polyurethane resins, phenol resins, alkyd resins, melamine resins, epoxy resins, silicone resins, acryl resins, methacryl resins, polycarbonate resins, polyarylate resins, phenoxy resins, polyvinylbutyral resins, polyvinylformal resins and copolymer resins containing two or more of the repeat units constituting these resins. Examples of the copolymer resin include insulating resins such as a vinyl chloride/vinyl acetate copolymer resin, a vinyl chloride/vinyl acetate/maleic acid anhydride copolymer resin and an acrylonitrile/styrene copolymer resin. The binder resin is not limited to these resins and resins usually used in the fields concerned may be used as the binder resin. These binder resins may be used either singly or in combinations of two or more.

The ratio of the binder resin is, though not limited to, about 0.5 to 2.0 parts by weight based on 100 parts by weight of the charge generation material.

The charge generation layer may contain one or more of a hole transport material, an electron transport material, an antioxidant, an ultraviolet absorber, a dispersion stabilizer, a sensitizer, a leveling agent, a plasticizer, and microparticles of an inorganic or organic compound as necessary.

The formulation of the plasticizer and the leveling agent brings about improvements in film forming ability, flexibility and surface smoothness.

Examples of the plasticizer include dibasic acid esters such as phthalates, fatty acid esters, phosphates, chlorinated paraffin and epoxy type plasticizers.

Examples of the leveling agent include silicone type leveling agents.

The charge generation layer may be formed by the known dry method or wet method.

Examples of the dry method include a method in which a charge generation material is deposited under vacuum on a conductive support.

Examples of the wet method include a method in which a charge generation material and, as required, a binder resin are dissolved or dispersed in a organic proper solvent to prepare a charge generation layer coating solution, which is then applied to the surface of a conductive support or to an intermediate layer formed on this conductive support, followed by drying to remove the organic solvent.

Examples of the solvent used in the charge generation layer coating solution include halogenated hydrocarbons such as dichloromethane and dichloroethane; ketones such as acetone, methyl ethyl ketone and cyclohexanone; esters such as ethyl acetate and butyl acetate; ethers such as tetrahydrofuran (THF) and dioxane; alkyl ethers of ethylene glycol such as 1,2-dimethoxyethane; aromatic hydrocarbons such as benzene, toluene and xylene; and aprotic polar solvents such as N,N-dimethylformamide and N,N-dimethylacetamide. Among these solvents, non-halogen type organic solvents are preferably used in consideration of global environment. These solvents may be used either singly or in combinations of two or more.

The charge generation material may be milled using a mill in advance before it is dissolved or dispersed in a solvent. Examples of the mill used in the milling treatment include a ball mill, a sand mill, an attritor, a vibration mill and an ultrasonic dispersing machine.

A dispersing machine such as a paint shaker, a ball mill or a sand mill may be used to dissolve or disperse the charge generation material in a solvent. At this time, it is preferable to design adequate dispersing conditions to avoid the situation where impurities are generated by abrasion from the members constituting the container and the dispersing machine and are mixed in the coating solution.

As the method of coating the charge generation layer coating solution, an optimum method may be properly selected in consideration of the physical properties of the coating solution and productivity. Examples of the method include a spray method, a bar coating method, a roll coating method, a blade method, a ring method and a dip coating method.

Among these coating methods, the dip coating method is a method in which a substrate is dipped in a coating vessel filled with a coating solution and then pulled up at a constant speed or a sequentially varied speed to thereby form a layer on the surface of the substrate. This method is relatively simple and is excellent in productivity and production cost. Therefore, this method may be preferably used in the production of a photoreceptor. In the device used for the dip coating method, a coating solution dispersing machine typified by an ultrasonic generating machine may be installed to stabilize the dispersibility of the coating solution.

The temperature in the process of drying the coating film is properly 50 to 140° C. and more preferably 80 to 130° C., though there is no particular limitation as long as the temperature is high enough to remove the used organic solvent.

When the drying temperature is less than 50° C., there is a case where the drying time is prolonged. Also, when the drying temperature exceeds 140° C., there is a fear that the electric characteristics of the photoreceptor in repeated use are deteriorated, with the result that the obtained image is deteriorated.

The temperature condition used in the production of the photosensitive layer is the same as in the production of other layers such as an intermediate layer and in other treatments which will be described later.

The film thickness of the charge generation layer is preferably 0.05 to 5 μm and more preferably 0.1 to 1 μm though no particular limitation is imposed on it.

When the film thickness of the charge generation layer is less than 0.05 μm, there is a fear as to deterioration in light absorption efficiency and in the sensitivity of the photoreceptor. Also, when the film thickness of the charge generation layer exceeds 5 μm, the mobility of charges inside the charge generation layer determines the process of removing the charges on the surface of the photoreceptor and there is therefore a fear as to deterioration in the sensitivity of the photoreceptor.

(Charge Transport Layers 12a, 12b, 12c, and 12d)

The charge transport layer 12a contains the amine type compound of the present invention as the charge transport material and a binder resin.

The content of the amine type compound of the present invention is 5 to 70% by weight, preferably 20 to 50% by weight and more preferably 30 to 40% by weight in the charge transport layer.

If the content of the amine type compound is less than 5% by weight, charges cannot be transported and there is therefore a fear as to deterioration in sensitivity. Also, if the content of the amine type compound exceeds 70% by weight, there is a fear as to a reduction in film strength.

The binder resin may be contained to improve, for example, the mechanical strength and durability of the charge transport layer.

Among resins which have binding ability and are used in the field concerned, a transparent resin which does not absorb light having a wavelength of 400 to 450 nm may be used as the binder resin. The same resins as those contained in the charge generation layer may be used either singly or in combinations of two or more.

Among these resins, polystyrene, polycarbonate, polyarylate and polyphenylene oxide respectively have a volume resistance of 10¹³Ω or more and therefore have excellent electric insulation, and are also excellent in film forming ability and potential characteristics and are therefore preferable, and polycarbonate being more preferable.

The ratio of the binder resin is about 50 to 300 parts by weight based on 100 parts by weight of the charge transport material, though there is no particular limitation to the ratio.

The charge transport layer may contain one or more of a hole transport material, an electron transport material, an antioxidant, an ultraviolet absorber, a dispersion stabilizer, a sensitizer, a leveling agent, a plasticizer, and microparticles of an inorganic or organic compound as necessary.

The formulation of these antioxidant and ultraviolet absorber makes it possible to reduce the deterioration of the photosensitive layer caused by oxidizing gases such as ozone and nitrogen oxide and to improve the stability of the coating solution. Therefore, these ingredients are preferably contained in the outermost charge transport layer of the photoreceptor.

Examples of the antioxidant include a phenol type compound, a hydroquinone type compound, a tocopherol type compound and an amine type compound. Among these compounds, hindered phenol derivatives, hindered amine derivatives and mixtures of these compounds are especially preferable.

The content of the antioxidant is preferably 0.1 to 50 parts by weight based on 100 parts by weight of the charge transport material.

When the content of the antioxidant is less than 0.1 parts by weight, there is a fear that no sufficient effect of improving the stability of the coating solution and no sufficient effect of improving the durability of the photoreceptor can be obtained. When the content of the antioxidant exceeds 50 parts by weight, there is a fear that the characteristics of the photoreceptor are adversely affected.

The charge transport layer may be formed by preparing a charge transport layer coating solution and applying the coating solution by the wet method, particularly, the dip coating method in the same manner as in the case of the charge generation layer.

As the solvent used to prepare the charge transport layer coating solution, the same solvents as those used in the preparation of the charge generation layer coating solution may be used either singly or in combinations of two or more.

Other processes and the conditions in the processes accord to those used in the formation of the charge generation layer.

The film thickness of the charge transport layer is, though not particularly limited, preferably 5 to 40 μm and more preferably 10 to 30 μm.

When the film thickness of the charge transport layer is less than 5 μm, the charge retentivity of the surface of the photoreceptor is deteriorated and there is therefore a fear as to a reduction in the contrast of the output image. Also, when the film thickness of the charge transport layer exceeds 100 μm, there is a fear that the productivity of the photoreceptor is deteriorated.

(Intermediate Layers (Undercoat Layers) 14b and 14d)

The photoreceptor of the present invention is preferably provided with an intermediate layer between the conductive support and the laminate type photosensitive layer as shown in FIG. 2 and FIG. 4.

The intermediate layer has a function of preventing charges from being injected into the laminate type photosensitive layer from the conductive support. In other words, deterioration in the chargeability of the laminate type photosensitive layer is limited and therefore, a reduction in the surface charge is limited on a part other than the parts from which charges must be eliminated by the exposure to light, thereby preventing the occurrence of image defects such as fogging. Particularly, the intermediate layer prevents the occurrence of image defects and particularly many image fogs called black dot which is a phenomenon that toners are stuck to the white background to form fine spots in the case of forming an image in the reverse developing process.

Also, the intermediate layer with which the surface of the conductive support is coated can reduce the degree of irregularities that are defects of the surface of the conductive support to make the surface uniform, improves the film formation ability of the laminate type photosensitive layer, and improves the adhesion between the conductive support and the laminate type photosensitive layer.

The intermediate layer may be formed, for example, by dissolving a resin material in an appropriate solvent to prepare an intermediate layer coating solution and by applying this coating solution to the surface of the conductive support, followed by drying to remove the organic solvent.

Examples of the resin material include natural macromolecular materials such as casein, gelatin, polyvinyl alcohol and ethyl cellulose, besides the same binder resins that are contained in the charge generation layer and the charge transport layer. These resin materials may be used either singly or in combinations of two or more. Among these resins, polyamide resins are preferable and alcohol-soluble nylon resins are particularly preferable. Examples of the alcohol-soluble nylon resins include the so-called copolymer nylons obtained by copolymerizing, for example, 6-nylon, 6,6-nylon, 6,10-nylon, 11-nylon, 2-nylon or 12-nylon, and resins obtained by chemically denaturing nylon such as N-alkoxymethyl denatured nylon and N-alkoxyethyl denatured nylon.

Examples of the solvent used to dissolve or disperse the resin material include water, alcohols such as methanol, ethanol and butanol; grimes such as methyl carbitol and butyl carbitol; chlorine type solvents such as dichloroethane, chloroform or trichloroethane; acetone; dioxorane; and mixed solvents obtained by blending two or more of these solvents. Among these solvents, non-halogen type organic solvents are preferably used in consideration of the global environment.

Other processes and other conditions conform to those in the formation of the charge generation layer or the charge transport layer.

Also, the intermediate layer coating solution may contain metal oxide particles.

The metal oxide particles ensure that the volume resistance of the intermediate layer can be controlled with ease, the injection of charges into the laminate type photosensitive layer can be more suppressed and also, the electric characteristics of the photoreceptor can be maintained in various circumstances.

Examples of the metal oxide particles include titanium oxide, aluminum oxide, aluminum hydroxide and tin oxide particles.

When the total weight of the binder resin and the metal oxide particles in the intermediate layer coating solution is defined as C and the weight of the solvent is defined as D, the ratio by weight of (C/D) is preferably 1/99 to 40/60 and more preferably 2/98 to 30/70.

Also, the ratio by weight (E/F) of the weight (E) of the resin material to the weight (F) of the metal oxide particles is preferably 90/10 to 1/99 and more preferably 70/30 to 5/95.

The film thickness of the intermediate layer is, though not particularly limited, preferably 0.01 to 20 μm and more preferably 0.05 to 10 μm.

When the film thickness of the intermediate layer is less than 0.01 μm, the resulting intermediate layer does not substantially play its role and there is a fear that it fails to cover defects of the conductive support to give a uniform surface. Specifically, the injection of charges from the conductive support into the laminate type photosensitive layer cannot be prevented, causing a reduction in the chargeability of the laminate type photosensitive layer. Also, when the film thickness of the intermediate layer exceeds 20 μm, it is difficult to form a uniform intermediate layer and also, it is difficult to form a uniform laminate type photosensitive layer on the intermediate layer, and there is a fear that the sensitivity of the photoreceptor is deteriorated.

When the constituent material of the conductive support is aluminum, a layer containing alumite (alumite layer) may be formed as the intermediate layer.

(Protective Layers 15c and 15d)

The photoreceptor of the present invention may include a protective layer on the laminate type photosensitive layer as shown in FIGS. 3 and 4.

The protective layer has a function of improving the durability of the photoreceptor, is made of a binder resin and may contain one or more types of the transport materials same as those contained in the charge transport layer.

Examples of the binder resin include the same binder resins as those used in the charge generation layer and the charge transport layer.

The protective layer may be formed, for example, by dissolving a binder resin in an appropriate solvent to prepare a protective layer coating solution and applying this coating solution to the surface of the laminate type photosensitive layer, followed by drying to remove the organic solvent.

Other processes and other conditions accord to those in the formation of the charge generation layer or the charge transport layer.

The film thickness of the protective layer is, though not particularly limited, preferably 0.5 to 10 μm and more preferably 1 to 5 μm.

When the film thickness of the protective layer is less than 0.5 μm, the scratch resistance of the surface of the photoreceptor is deteriorated and there is therefore a fear as to insufficient durability. Also, when the film thickness of the protective layer exceeds 10 μm, there is a fear that the resolution of the photoreceptor is deteriorated.

The image formation apparatus of the present invention comprises the multilayered electrophotographic photoreceptor according to the present invention, a charge means for charging the multilayered electrophotographic photoreceptor, an exposure means for exposing the charged multilayered electrophotographic photoreceptor to coherent light having a wavelength range from 400 to 450 nm to form an electrostatic latent image, a developing means for developing the electrostatic latent image formed by the exposure to visualize the image, and a transfer means for transfer the image visualized by the developing to a recording medium.

The image formation apparatus of the present invention and its operation will be described with reference to the drawings, though the present invention is not limited by the following descriptions.

FIG. 5 is a schematic side view showing a structure of an image formation apparatus according to the present invention.

An image formation apparatus (laser printer) 100 shown in FIG. 5 has a structure including a photoreceptor 1 of the present invention, an exposure means (semiconductor laser) 31, a charging means (charging device) 32, a developing means (developing device) 33, a transfer means (transfer charging device) 34, a conveyer belt (not shown), a fixing means (fixing device) 35 and a cleaning means (cleaner) 36. A piece of transfer paper 51 is shown in the drawing.

The photoreceptor 1 is supported in a freely rotational manner by the image formation apparatus 100 main body which is not illustrated and is rotated in the direction of an arrow 41 around a rotation axis 44 by a drive means (not shown). The drive means has, for example, a structure including an electric motor and a reduction gear, and transmits its drive force to the conductive support constituting the core body of the photoreceptor 1 to thereby rotate the photoreceptor 1 at a predetermined peripheral speed. The charging means 32, the exposure means 31, the developing means 33, the transfer means 34 and the cleaning means 36 are disposed in this order towards the down stream side from the upstream side in the direction of the rotation of the photoreceptor 1 as shown by the arrow 41 along the outside periphery of the photoreceptor 1.

The charging means 32 is a charging means that uniformly charges the outside periphery of the photoreceptor 1 to a predetermined potential.

The exposure means 31 is provided with a blue semiconductor laser as the light source and applies a laser beam emitted from the light source to the surface of the photoreceptor 1 between the charging means 32 and the developing means 33 to expose the outside periphery of the charged photoreceptor 1 to light corresponding to image information. The photoreceptor 1 is scanned repeatedly by the light in the major scanning direction parallel to the rotation axis 44 of the photoreceptor 1 and an image is formed along with this scanning operation, to form electrostatic latent images in this order on the surface of the photoreceptor 1. In other words, the amounts of charges on the surface of the photoreceptor 1 uniformly charged by the charging means 32 are made to be different between the part irradiated with the laser beam and the part non-irradiated with the laser beam, whereby an electrostatic latent image is formed.

In the image formation apparatus of the present invention, the exposure means is preferably a blue semiconductor laser.

Also, the blue semiconductor laser is preferably one using a gallium nitride type material.

The developing means 33 is a developing means that develops the electrostatic latent image formed by exposure on the surface of the photoreceptor 1 by a developer (toner). The developing means 33 is disposed facing the photoreceptor 1 and provided with a developing roller 33a that supplies a toner to the outside peripheral surface of the photoreceptor 1 and a casing 33b that supports the developing roller 33a in such a manner as to be rotatable around the rotating axis parallel to the rotating axis 44 of the photoreceptor 1 and that stores a developer containing the toner in its inside space.

The transfer means 34 is a transfer means that transfers the toner image which is a visible image formed on the outside peripheral surface of the photoreceptor 1 by developing, to the transfer paper 51 which is a recording medium supplied between the monolayer type photoreceptor 1 and the transfer charging means 34 from the direction of an arrow 42 by a conveying means (not shown). The transfer means 34 is, for example, a non-contact type transfer means that is provided with, for example, a charging means and provides charges having inverse polarity with respect to the toner to the transfer paper 51 to thereby transfer the toner image to the toner paper 51.

The cleaning means 36 is a cleaning means that removes and recovers the toner remaining on the outside peripheral surface of the photoreceptor 1 after the transfer operation by the transfer means 34. The cleaner 36 is provided with a cleaning blade 36a that peels the toner remaining on the outside peripheral surface of the monolayer type photoreceptor 1 and a recovery casing 36b storing the toner peeled by the cleaning blade 36a. Also, this cleaning means 36 is disposed together with a discharge lamp (not shown).

Also, the image formation apparatus 100 is provided with a fixing means 35 which is a fixing means that fixes the transferred image on the downstream side toward which the transfer paper 51 made to pass between the photoreceptor 1 and the transfer means 34 is conveyed. The fixing means 35 is provided with a heat roller 35a provided with a heating means (not shown) and a pressure roller 35b that is disposed facing the heat roller 35a and pressed by the heat roller 35a to form a contact part.

The image formation apparatus 100 also includes a separating means 37 that separates the transfer paper from the photoreceptor and a casing 38 storing various means of the image formation apparatus.

The image formation action of this electrophotographic device 100 is made as follows.

First, when the photoreceptor 1 is rotated in the direction of the arrow 41 by a drive means, the surface of the photoreceptor 1 is positively charged uniformly to a prescribed potential by the charging means 32 disposed on the upstream side of the image point of the light of the exposure means 31 in the direction of the rotation of the photoreceptor 1.

Then, the surface of the photoreceptor 1 is irradiated with the light emitted from the exposure means 31 corresponding to image information. In the photoreceptor 1, the surface charge on the part which is irradiated with the light is removed by the exposure, which causes a difference in surface potential between the part irradiated with the light and the part which is not irradiated with the light, resulting in the formation of an electrostatic latent image.

The toner is supplied to the surface of the photoreceptor 1 from the developing means 33 disposed on the downstream side of the image point of the light of the exposure means 31 in the direction of the rotation of the photoreceptor 1, to develop the electrostatic latent image, thereby forming a toner image.

The transfer paper 51 is fed between the photoreceptor 1 and the transfer means 34 synchronously with the exposure for the photoreceptor 1. Charges having polarity opposite to that of the toner are provided to the fed transfer paper 51 by the transfer means 34 to transfer the toner image formed on the surface of the photoreceptor 1 to the surface of the transfer paper 51.

The transfer paper 51 with the image transferred thereto is conveyed to the fixing means 35 by a conveying means, and heated and pressurized when it is made to pass through the contact part between the heat roller 35a and the pressure roller 35b of the fixing means 35 to fix the toner image to the transfer paper 51, thereby forming a fast image. The transfer paper 51 on which an image is thus formed is discharged out of the electrophotographic device 100 by a conveying means.

The toner left on the surface of the photoreceptor 1 after the toner image is transferred by the transfer means 34 is peeled from the surface of the monolayer type photoreceptor 1 by the cleaner 36 and recovered. The charges on the surface of the photoreceptor 1 from which the toner is removed in this manner is removed by light emitted from a discharge lamp, so that the electrostatic latent image on the surface of the photoreceptor 1 disappears. Thereafter, the photoreceptor 1 is further rotated and then, a series of operations beginning with the charging operation are again repeated to form images continuously.

### EXAMPLES

The present invention will be explained in detail by way of production examples, examples and comparative examples, which are, however, not intended to limit the present invention.

The chemical structure, molecular weight and elemental analysis of each compound obtained in the production examples were measured using the following devices and under the following conditions.

### (Chemical Structure)

Nuclear magnetic resonance Spectrometer: NMR (model: DPX-200, manufactured by Bruker Biospin k.k.)

Preparation of a sample: About 4 mg of sample/0.4 m (CDCl₃)

Measuring mode: ¹H (normal)

### (Molecular Weight)

Molecular weight measuring device: LC-MS (manufactured by Thermoquest, Finnigan LCQ Deca Mass spectrometer system)

LC column: GL-Sciences Inertsil ODS-3 2.1×100 mm

Column temperature: 40° C.

Eluate:methanol:water=90:10

Injection amount of sample: 5 μl

Detector: UV 254 nm and MS ESI

### (Elemental Analysis)

Elemental analysis device: Elemental Analysis 2400, manufactured by PerkinElmer Inc.

Amount of sample: about 2 mg was weighed precisely

Flow rate of gas (mil/min.): He=1.5, O₂=1.1, N_{2=4.3}

Combustion tube temperature setting: 925° C.

Reducing tube temperature setting: 640° C.

The elemental analysis was made by the carbon (C), hydrogen (H) and nitrogen (N) simultaneous quantification method according to the differential heat conductivity method.

### Production Example 1

### Exemplified Compound No. 1-3

The exemplified compound No. 1-3 represented by the following formula was produced.

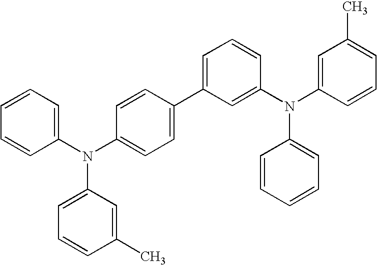

Under a nitrogen atmosphere, 144 mg of palladium acetate and 0.64 mL of tri-tert-butylphosphine were added to 60 mL of dehydrated xylene and 24.84 g of 3-bromoiodobenzene, 49.68 g of N-phenyl-m-toluidine and 10.19 g of sodium-tert-butoxide were added to the mixture at ambient temperature. Then, the mixture was refluxed under heating at 140° C. for 5 hours. Then, the reaction solution was subjected to extraction treatment, drying, refining using column chromatography and recrystallization to obtain 13.46 g of 3-bromophenyl-3′-methylphenyl-phenylamine.

Then, 4.0 g of the obtained 3-bromophenyl-3′-methylphenyl-phenylamine was dissolved in 50 mL of tetrahydrofuran under a nitrogen atmosphere. To the resulting solution, 8.8 mL of an n-butyllithium-hexane (1.5 M) solution was added dropwise at −78° C., which was then stirred for 20 min., and then, 10 mL of a tetrahydrofuran solution containing 3.0 mL of trimethoxyborane was added dropwise to the mixture. Thereafter, the reaction solution was adjusted to pH 2 by adding an acid. The obtained reaction solution was subjected to extraction, drying, concentration and recrystallization to obtain 2.6 g of a boronic acid compound (yield: 70%).

Then, 1.36 g of the obtained boronic acid compound and 1.92 g of 3-bromophenyl-3′-methylphenyl-phenylamine were refluxed in a tetrahydrofuran-water two-layer system solvent in the presence of 1.24 g of potassium carbonate and 260 mg of tetrakistriphenylphosphine palladium (0) for 20 hours to obtain 1.4 g of the exemplified compound No. 1-3 (yield: 60%).

The results of analysis of the obtained exemplified compound No. 1-3 are shown below.

### (Chemical Structure)

The results of ¹H-NMR spectrum were as follows: δ (ppm)=2.2 (s, 6H), 6.4-7.2 (m, 26H).

### (Molecular Weight)

In LC-MS, a peak was observed corresponding to a molecular ion [M+H]⁺ having a molecular weight of 517.4 obtained by adding the amount of protons to the calculated value (516.67) of the molecular weight of the exemplified compound No. 1-3.

### (Elemental Analysis)

Theoretical value: C, 88.34%, H, 6.24%, N, 5.42%

Measured value: C, 88.16%, H, 6.01%, N, 5.18%

It was found from the above results of analyses such as NMR, LC-MS and elemental analysis that the obtained compound was a triphenylamine dimer compound of the exemplified compound No. 1-3.

Also, from the results of analysis of HPLC when LC-MS was measured, it was found that the purity of the obtained exemplified compound No. 1-3 was 98.7%.

### Production Example 2

### Exemplified Compound No. 2-3

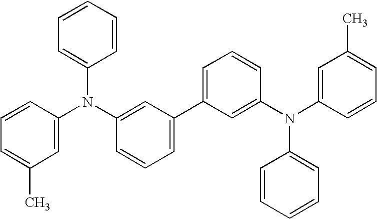

Under a nitrogen atmosphere, 36 mg of palladium acetate and 0.16 mL of tri-tert-butylphosphine were added to 20 mL of dehydrated xylene and 12.42 g of 4-bromoiodobenzene, 3.65 g of N-phenyl-m-toluidine and 2.55 g of sodium-tert-butoxide were added to the mixture at ambient temperature. Then, the mixture was refluxed under heating at 140° C. for 5 hours. Then, the reaction solution was subjected to extraction treatment, drying, refining using column chromatography and recrystallization to obtain 4.04 g of 4-bromophenyl-3′-methylphenyl-phenylamine.

Then, 1.36 g of the obtained boronic acid compound obtained in Production Example 1 and 1.92 g of 4-bromophenyl-3′-methylphenyl-phenylamine were refluxed in a tetrahydrofuran-water two-layer system solvent in the presence of 1.24 g of potassium carbonate and 260 mg of tetrakistriphenylphosphine palladium (0) for 20 hours to obtain 1.58 g of the exemplified compound No. 2-3 (yield: 68%).

The results of analysis of the obtained exemplified compound No. 2-3 are shown below.

### (Chemical Structure)

The results of ¹H-NMR spectrum were as follows: δ (ppm)=2.2 (s, 3H), 2.3 (s, 3H), 6.3-7.6 (m, 26H).

### (Molecular Weight)

In LC-MS, a peak was observed corresponding to a molecular ion [M+H]⁺ having a molecular weight of 517.7 obtained by adding the amount of protons to the calculated value (516.67) of the molecular weight of the exemplified compound No. 2-3.

### (Elemental Analysis)

Theoretical value: C, 88.34%, H, 6.24%, N, 5.42%

Measured value: C, 88.12%, H, 6.05%, N, 5.15%

It was found from the above results of analyses such as NMR, LC-MS and elemental analysis that the obtained compound was a triphenylamine dimer compound of the exemplified compound No. 2-3.

Also, from the results of analysis of HPLC when LC-MS was measured, it was found that the purity of the obtained exemplified compound No. 2-3 was 98.8%.

### Example 1

A photoreceptor was manufactured by compounding the exemplified compound No. 1-3, which is the amine type compound produced in Production Example 1 according to the present invention, in the charge transport layer.

An aluminum cylindrical conductive support having a diameter of 30 mm and a length of 340 mm was used as the conductive support.

To a mixed solvent consisting of 41 parts by weight of 1,3-dioxolan and 41 parts by weight of methanol, 9 parts by weight of titanium oxide (trade name: Tipaque TTO-D-1, manufactured by Ishihara Sangyo Kaisha, Ltd.) and 9 parts by weight of a copolymer nylon resin (trade name: Amilan CM8000, manufactured by Toray Industries Ltd.) were added. The mixture was dispersed by a paint shaker for 12 hours to prepare an intermediate layer coating solution.

The obtained intermediate layer coating solution was applied to a PET film which was used as the conductive support and on which aluminum was vapor-deposited by the applicator coating method to form an intermediate layer having a film thickness of 1 μm.

Then, 1 part by weight of a perylene type pigment, Pigment Red 149 (trade name: PV Fast Red B, manufactured by Clariant (Japan) k.k.) having the following structure as the charge generation material and 1 part by weight of a butyral resin (trade name: #6000-C, manufactured by Denki Kagaku Kogyo Kabushiki kaisha) as a binder resin were added to 98 parts by weight of methyl ethyl ketone. The mixture was dispersed by a paint shaker for one hour to prepare a charge generation layer coating solution.

The obtained charge generation layer coating solution was applied to the surface of the intermediate layer formed previously in the same manner as in the case of the above intermediate layer and naturally dried to form a charge generation layer 0.4 μm in film thickness.

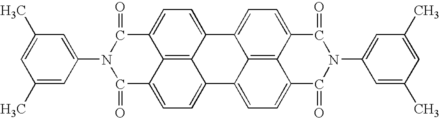

Then, 5 parts by weight of the exemplified compound 1-3 produced in Production Example 1 as the charge transport material and 9 parts by weight of a polycarbonate resin (trade name: PCZ-400, manufactured by Mitsubishi Gas Chemical Company) as a binder resin were blended using 86 parts by weight of tetrahydrofuran as a solvent to prepare a charge transport layer coating solution.

The obtained charge transport layer coating solution was applied to the surface of the charge generation layer formed previously in the same method as in the case of the above intermediate layer and dried in hot air at 110° C. for 60 minutes to form a charge transport layer 20 μm in film thickness.

The laminate type photoreceptor of the present invention in which the intermediate layer, the charge generation layer and the charge transport layer are formed in this order on the conductive support as shown in FIG. 3 was thus manufactured.

On the other hand, only the charge transport layer coating solution was applied to a 100-μm-thick PET film by the applicator coating method and dried in hot air at 110° C. for 60 minutes to prepare a sample for measurement of transmittance which was provided with a charge transport layer 20 μm in film thickness.

### Example 2

A laminate type photoreceptor according to the present invention was manufactured in the same manner as in Example 1 except that the exemplified compound No. 2-3 produced in Production Example 2 was used in place of the exemplified compound No. 1-3 produced in Production Example 1.

Also, a sample for measurement of transmittance was produced in the same manner as in Example 1.

### Comparative Example 1

A laminate type photoreceptor was manufactured in the same manner as in Example 1 except that a compound having the following structure was used in place of the exemplified compound No. 1-3 produced in Production Example 1.

Also, a sample for measurement of transmittance was produced in the same manner as in Example 1.

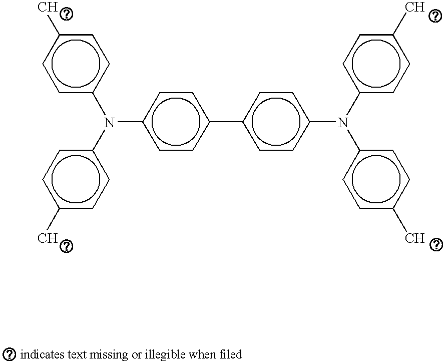

### Comparative Example 2

A laminate type photoreceptor was manufactured in the same manner as in Example 1 except that a compound having the following structure was used in place of the exemplified compound No. 1-3 produced in Production Example 1.

Also, a sample for measurement of transmittance was produced in the same manner as in Example 1.

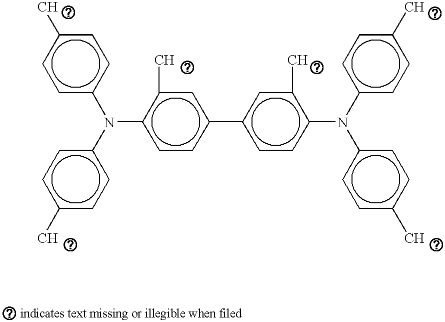

### (Evaluation)

(1) An electrostatic paper tester (trade name: EPA-8200, manufactured by Kawaguchi Electric Works Co., Ltd.) was used to evaluate the electric characteristics (photosensitivity) of each laminate type photoreceptor produced in Examples 1 and 2 and Comparative Examples 1 and 2.

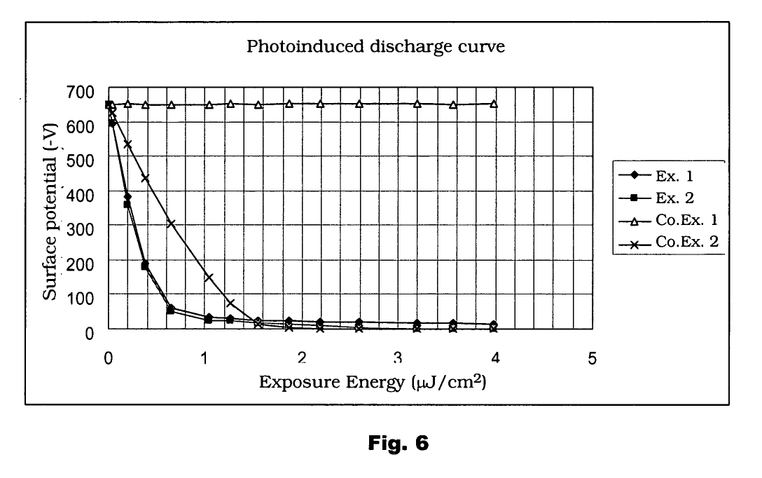

Specifically, the laminate type photoreceptors were negative charged such that the surface potential became −600 V, and the surface of the laminate type photoreceptors was exposed to the light obtained by spectrally dividing 300 W xenon lamp light by an interference filter and by adjusting the selected light to wavelength 400 nm and an intensity of 5 μW/cm² by an ND filter to measure the amount of exposure required to halve the surface potential of the photoreceptor down to −300 V as the half decay exposure energy E1/2 (μJ/cm²). The obtained results are shown in Table 1 and FIG. 6.

(2) A spectrophotometer (manufactured by Hitachi High-Technologies Corporation) was used to measure the transmittance T (%) at a wavelength 405 nm of the sample for measuring the transmittance of the charge transport layer produced when each laminate type photoreceptor was produced in Examples 1 and 2 and Comparative Examples 1 and 2. The obtained results are shown in Table 1.

TABLE 1

| | Half Decay | |
|---|---|---|
| | Exposure Energy | |
| | E1/2 | Transmittance* |
| | (μJ/cm²) | T (%) |
| Example 1 | 0.28 | 61.8 |
| Example 2 | 0.27 | 75.8 |
| Comparative Example 1 | No sensitive | 5.0 |
| Comparative Example 2 | 0.63 | 80.5 |

*Wavelength 405 nm

It was found that each laminate type photoreceptor of Examples 1 and 2 using the amine type compound according to the present invention as the charge transport material has higher sensitivity than each laminate type photoreceptor of Comparative Examples 1 and 2 using conventional triarylamine. This is inferred to be because each laminate type photoreceptor of Examples 1 and 2 well transmits light having a wavelength of 405 nm which is the wavelength of a blue semiconductor laser and is also improved in charge mobility at the same time.

The photosensitivity of the laminate type photoreceptor of Comparative Example 1 could not be observed. This is inferred to be because the transmittance of the charge transport layer was low and almost no light reached the charge generation layer.

The laminate type photoreceptor of Comparative Example 2 had low sensitivity though it had the similar transmittance to each laminate type photoreceptor of Examples 1 and 2. This is inferred to be because the charge mobility was reduced by steric hindrance of the substituent of the charge transport material.

What is claimed is:

1. A multilayered electrophotographic photoreceptor comprising at least a charge generation layer containing a charge generation material and a charge transport layer containing a charge transport material in this order, on a conductive support, wherein the charge transport layer contains, as the charge transport material, an amine type compound represented by the following formula (I): 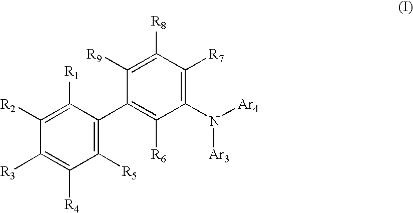
wherein R₁ to R₉, which may be the same or different, respectively represent a hydrogen atom; a halogen atom; or an alkyl, cycloalkyl, alkenyl or alkoxy group which may have a substituent, provided that either one of R₂ and R₃ represents —N(Ar₁)(Ar₂); and Ar₁ to Ar₄, which may be the same or different, respectively represent an aromatic hydrocarbon residue or an aromatic heterocyclic residue which may have a substituent, and Ar₁ and Ar₂, or Ar₃ and Ar₄ may be combined with each other to form a condensed ring; and has photosensitive properties in coherent light of wavelength range from 400 to 450 nm.

2. The multilayered electrophotographic photoreceptor of claim 1, wherein R₁, R₅, R₆ and R₉ in the formula (I) are respectively a hydrogen atom.

3. The multilayered electrophotographic photoreceptor of claim 1, wherein the substituent is a halogen atom or a lower alkyl group having 1 to 4 carbon atoms.

4. The multilayered electrophotographic photoreceptor of claim 1, wherein R₂, R₄, R₇ and R₈ in the formula (I) are respectively a hydrogen atom, R₃ is —N(Ar₁)(Ar₂) and Ar₁, Ar₂, Ar₃ and Ar₄ are respectively a group selected from phenyl, m-tolyl, p-tolyl, mesityl, 1-naphthyl, 2-naphthyl, 4-biphenylyl, m-ethylphenyl and 9-anthryl or a 9-carbazolyl group formed from Ar₁ and Ar₂ combined with each other.

5. The multilayered electrophotographic photoreceptor of claim 4, wherein a combination of Ar₁ and Ar₂ is the same as a combination of Ar₃ and Ar₄.

6. The multilayered electrophotographic photoreceptor of claim 1, wherein R₂, R₄ and R₈ in the formula (I) are respectively a hydrogen atom, R₇ is a hydrogen atom or a methyl group, R₂ is —N(Ar₁)(Ar₂) and Ar₁, Ar₂, Ar₃ and Ar₄ are respectively a group selected from phenyl, m-tolyl, p-tolyl, 2-naphthyl, 4-biphenylyl, 9-phenanthryl and 9-anthryl.

7. The multilayered electrophotographic photoreceptor of claim 6, wherein a combination of Ar₁ and Ar₂ is the same as a combination of Ar₃ and Ar₄.

8. The multilayered electrophotographic photoreceptor of claim 1, wherein the amine type compound is 3,4′-bis(N-phenyl-N-m-tolylamino)biphenyl or 3,3′-bis(N-phenyl-N-m-tolylamino)biphenyl.

9. The multilayered electrophotographic photoreceptor of claim 1, wherein the amine type compound is contained in the charge transport layer by ratio of 5 to 70% by weight.

10. The multilayered electrophotographic photoreceptor of claim 9, wherein the amine type compound is contained in the charge transport layer by ratio of 30 to 40% by weight.

11. The multilayered electrophotographic photoreceptor of claim 1, wherein an intermediate layer is provided between the conductive support and the laminate type photosensitive layer in order to prevent charges from being injected into the laminate type photosensitive layer from the conductive support and make the surface of the conductive support uniform.

12. An image formation apparatus comprising the multilayered electrophotographic photoreceptor of claim 1, a charge means for charging the multilayered electrophotographic photoreceptor, an exposure means for exposing the charged multilayered electrophotographic photoreceptor to coherent light having a wavelength range from 400 to 450 nm to form an electrostatic latent image, a developing means for developing the electrostatic latent image formed by the exposure to visualize the image, and a transfer means for transfer the image visualized by the developing to a recording medium.

13. The image formation apparatus of claim 12, wherein the exposure means is a blue semiconductor laser.

14. The image formation apparatus of claim 13, wherein the blue semiconductor laser is a gallium nitride type material.
